(19) United States
(12) Patent Application Publication
(10) Pub. No.: US 2025/0381796 A1
(43) Pub. Date: Dec. 18, 2025

(54) WHEEL BEARING APPARATUS FOR VEHICLE

(71) Applicant: HYUNDAI MOBIS CO., LTD., Seoul (KR)

(72) Inventor: Min Seok CHOI, Yongin-si (KR)

(73) Assignee: HYUNDAI MOBIS CO., LTD., Seoul (KR)

(21) Appl. No.: 19/010,808

(22) Filed: Jan. 6, 2025

(30) Foreign Application Priority Data
Jun. 13, 2024 (KR) 10-2024-0076982

(51) Int. Cl. B60B 27/00; B60B 27/02; F16C 33/66; F16C 33/76

(52) U.S. Cl. CPC B60B 27/0073; B60B 27/02; F16C 33/6681; B60B 27/0094; F16C 33/762

(57) ABSTRACT

A wheel bearing apparatus including a hub rotatably coupled to a wheel, an outer ring spaced apart from an outer side of the hub and fixed to a vehicle body, a slinger coupled to the hub, a frame coupled to the outer ring and spaced apart from the slinger, and a sealing portion provided on the frame, spaced apart from the hub, and configured to contact the slinger.

### CROSS-REFERENCE TO RELATED APPLICATION

This application claims priority from and the benefit under 35 USC § 119(a) of Korean Patent Application No. 10-2024-0076982, filed on Jun. 13, 2024, the entire disclosure of which is incorporated herein by reference for all purposes.

### BACKGROUND

### 1. Field

Exemplary embodiments according to the present disclosure relate to a wheel bearing apparatus for a vehicle, and more particularly, to a wheel bearing apparatus for a vehicle capable of preventing the entry of foreign substances and reducing drag torque.

### 2. Description of the Related Art

A wheel bearing for a vehicle is a device that is mounted between the vehicle body and the wheel to facilitate the rotation of the wheel. The wheel bearing provides the vehicle with an ability to move by rotatably supporting the wheel, which is a rotating element, on the vehicle body, which is a non-rotating element.

The wheel bearing may be classified into a drive wheel bearing, which transmits power generated by an engine, and a driven wheel bearing, which does not transmit driving force.

Since the wheel bearing is mounted on the wheel of a vehicle, the wheel bearing is easily exposed to foreign substances such as dust and moisture. Therefore, the wheel bearing is equipped with a sealing device to prevent foreign substances from entering the wheel bearing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a wheel bearing apparatus including a hub rotatably coupled to a wheel, an outer ring spaced apart from an outer side of the hub and fixed to a vehicle body, a slinger coupled to the hub, a frame coupled to the outer ring and spaced apart from the slinger, and a sealing portion provided on the frame, spaced apart from the hub, and configured to contact the slinger.

The slinger may include a slinger fixing portion fixed on a first surface of the hub, a slinger bending portion configured to bend from the slinger fixing portion in a radial direction of the hub, and a slinger extension portion configured to incline from the slinger bending portion toward an inner surface of the outer ring to form an acute angle with the slinger fixing portion.

The slinger further may include a sealing member provided on the slinger bending portion and configured to form a first seal between the first surface and the slinger fixing portion.

The frame may include a first frame fixing portion fixed to an end surface of the outer ring, a first frame bending portion configured to bend from one side of the first frame fixing portion in a first axial direction of the hub, a first frame extension portion configured to incline from the first frame bending portion toward a second surface of the hub, which intersects with the first surface of the hub, to form an obtuse angle with the first frame fixing portion, a second frame bending portion configured to bend from an opposite side of the first frame fixing portion in a second axial direction of the hub, opposite to the first axial direction, a second frame fixing portion coupled to the second frame bending portion and fixed to the inner surface of the outer ring, a third frame bending portion configured to bend from the second frame fixing portion in a central direction of the hub, and a second frame extension portion configured to incline from the third frame bending portion toward the first surface and positioned parallel to the slinger extension portion.

A free end of the slinger extension portion may be positioned between the second frame fixing portion and the second frame extension portion.

The sealing portion may include a sealing body portion provided on the frame and a sealing lip portion configured to protrude from the sealing body portion and to contact the slinger extension portion.

The sealing body portion may include a first sealing body portion configured to surround the first frame extension portion and spaced apart from a first portion of the second surface, a second sealing body portion provided on the second frame extension portion and from which the sealing lip portion protrudes, and a third sealing body portion configured to connect the first sealing body portion and the second sealing body portion.

The sealing body portion further may include a sealing extension portion configured to extend from the first sealing body portion to surround the first frame bending portion and to form a second seal between an outer surface of the outer ring and the first frame fixing portion.

The sealing lip portion may include a first sealing lip portion configured to extend from the second sealing body portion in the first axial direction and a second sealing lip portion spaced apart from the first sealing lip portion and configured to bend from the second sealing body portion to extend in the radial direction of the hub.

The hub may have a groove portion defined therein, the groove portion being recessed in a second portion of the second surface.

### BRIEF DESCRIPTION OF THE DRAWINGS

FIG. 1 is a perspective view showing a wheel bearing apparatus for a vehicle according to an embodiment of the present disclosure.

FIG. 2 is a side cross-sectional view showing a wheel bearing apparatus for a vehicle according to an embodiment of the present disclosure.

FIG. 3 is a partially enlarged cross-sectional view of FIG. 2.

FIG. 4 is a partially enlarged cross-sectional view of FIG. 3.

FIG. 5 is a partially enlarged cross-sectional view of FIG. 3 showing a guide path when moisture enters a wheel bearing apparatus for a vehicle according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

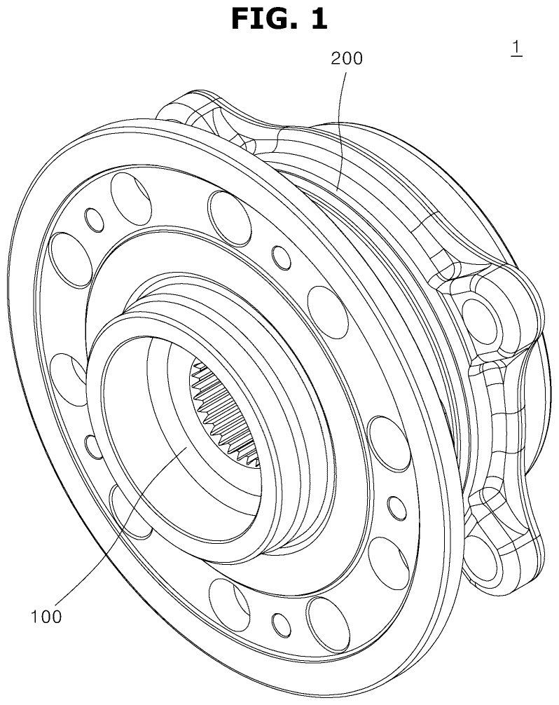

FIG. 1 is a perspective view showing a wheel bearing apparatus for a vehicle according to an embodiment of the present disclosure. FIG.

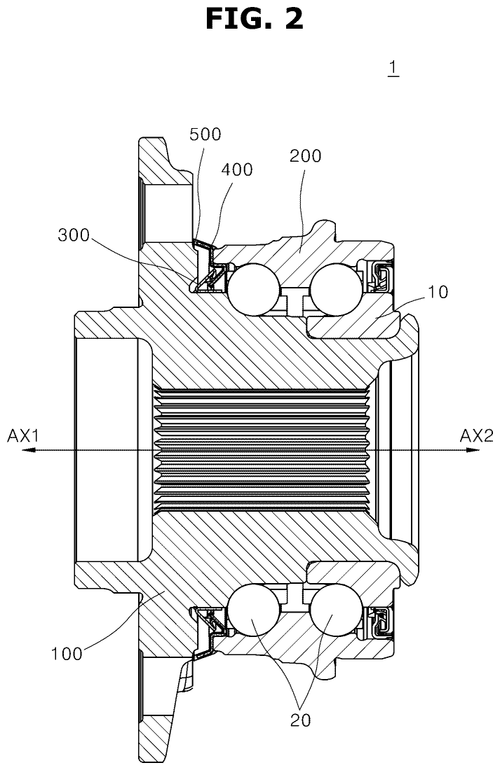

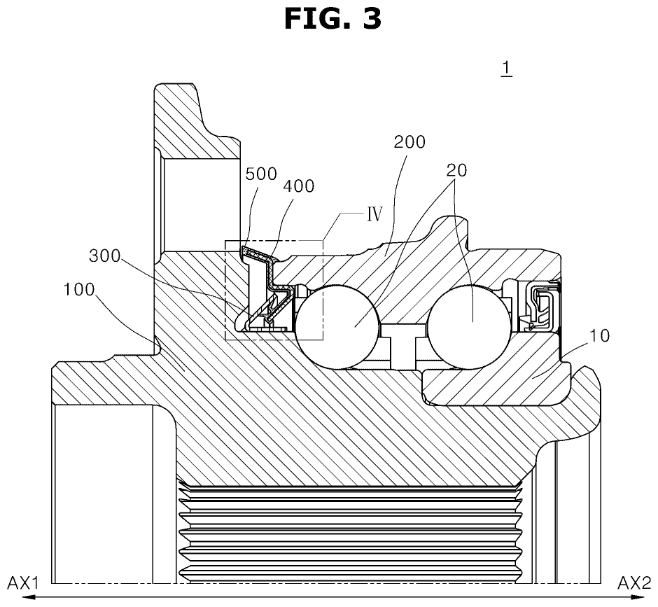

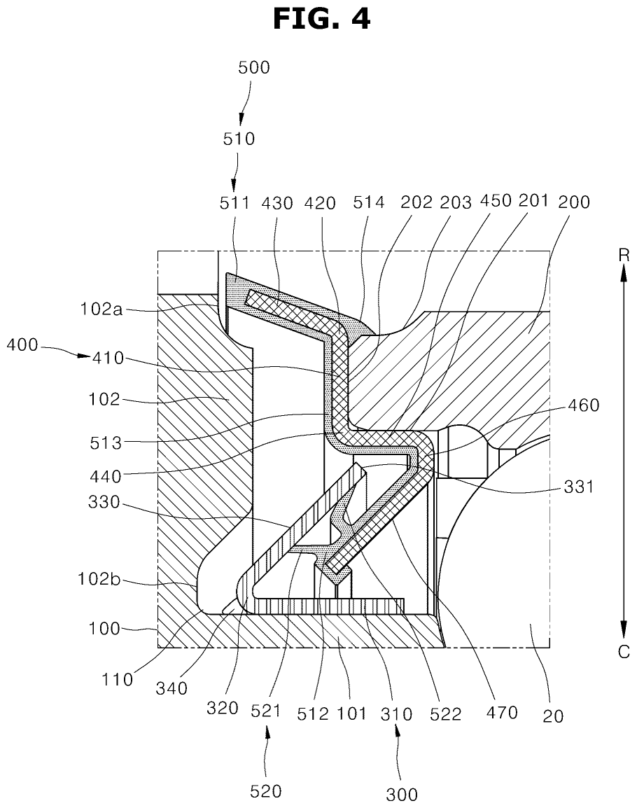

2 is a side cross-sectional view showing a wheel bearing apparatus for a vehicle according to an embodiment of the present disclosure. FIG. 3 is a partially enlarged cross-sectional view of FIG. 2. FIG. 4 is a partially enlarged cross-sectional view of FIG. 3.

Referring to FIGS. 1 to 4, a wheel bearing apparatus 1 for a vehicle according to an embodiment of the present disclosure includes a hub 100, an outer ring 200, a slinger 300, a frame 400 and a sealing portion 500, which will be described in detail as follows.

The hub 100 may form the outline of one side (left side in FIG. 2) of the wheel bearing apparatus 1 for a vehicle according to the embodiment of the present disclosure and support the outer ring 200, slinger 300, frame 400 and sealing portion 500, which will be described below.

The hub 100 may have a drive shaft (not shown) coupled to the inside. The hub 100 may rotate together with the drive shaft and function as a rotating element that transmits a rotational force generated from the drive shaft to a wheel.

The hub 100 may be formed in a hollow cylindrical shape and positioned in a direction parallel to the axial direction of the wheel. The drive shaft may be inserted into the inside of the hub 100 through a hollow of the hub 100.

The wheel bearing apparatus 1 for a vehicle according to the embodiment of the present disclosure may include an inner ring 10. The inner ring 10 may be coupled to the hub 100 and rotate together with the hub 100 when the hub 100 rotates. The inner ring 10 may have the drive shaft seated on one side.

The inner ring 10 may be configured to integrally perform a function of supporting the drive shaft, which is traditionally performed by a separate member such as a washer, steel plate, or the like.

The outer ring 200 may form the outline of the opposite side (right side in FIG. 2) of the wheel bearing apparatus 1 for a vehicle according to the embodiment of the present disclosure and be spaced apart from the hub 100 and the inner ring 10. The outer ring 200 may be fixed to the vehicle body to function as a non-rotating element that does not rotate together with the hub 100 and inner ring 10 when the wheel rotates.

The outer ring 200 may be formed in a hollow cylindrical shape. The outer ring 200 may be positioned to face outer circumferential surfaces of the inner ring 10 and hub 100 while being spaced a set distance apart in the radial direction R of the hub 100.

The wheel bearing apparatus 1 for a vehicle according to the embodiment of the present disclosure may include a bearing portion 20. The bearing portion 20 may be provided between the hub 100 and the outer ring 200, and between the inner ring 10 and the outer ring 200, and rotatably support the hub 100 and the inner ring 10 relative to the outer ring 200.

The bearing portion 20 may be provided in an empty space formed between the outer ring 200 and the hub 100, and between the outer ring 200 and the inner ring 10, thus supporting a relative rotation of the hub 100 and the inner ring 10 relative to the outer ring 200.

The bearing portion 20 may be a rolling bearing. The bearing portion 20 may include a rolling member. The rolling member may be a steel ball having a circular cross-section. The bearing portions 20 may be provided in pairs and spaced a set distance apart along the axial direction AX1 and AX2 of the hub 100. To facilitate rolling of the rolling member, the bearing portion 20 and an area around the bearing portion 20 may be filled with lubricating oil (grease).

The slinger 300 may be coupled to the hub 100. The slinger 300 may include metal, be formed in a ring shape, and be press-fitted onto an outer circumferential surface of the hub 100. The slinger 300 may include a slinger fixing portion 310, a slinger bending portion 320, and a slinger extension portion 330.

The slinger fixing portion 310 may be fixed to a first surface 101 of the hub 100. The slinger fixing portion 310 may be positioned in a direction parallel to the axial direction AX1 and AX2 of the hub 100 and be in close contact with the first surface 101 of the hub 100.

The slinger bending portion 320 may be provided on one side (left side in FIG. 4) of the slinger fixing portion 310. The slinger bending portion 320 may be formed to bend from an end of the slinger fixing portion 310 on one side in the radial direction R of the hub 100. The slinger bending portion 320 may be spaced apart from a second surface 102 of the hub 100, which intersects with the first surface 101 of the hub 100.

The slinger extension portion 330 may extend from the slinger bending portion 320 toward the outer ring 200. The slinger extension portion 330 may extend in an inclined manner at a set angle from an end of the slinger bending portion 320 toward an inner surface 201 of the outer ring 200. That is, the slinger extension portion 330 may incline from the end of the slinger bending portion 320 at the set angle.

The slinger extension portion 330 may form an acute angle with the slinger fixing portion 310. The interior angle between the slinger fixing portion 310 and the slinger extension portion 330 may be about 45 degrees or more and less than about 90 degrees. A free end 331 of the slinger extension portion 330 may be positioned between a second frame fixing portion 450 and a second frame extension portion 470, which will be described below.

The slinger 300 according to the embodiment of the present disclosure may further include a sealing member 340. The sealing member 340 may be provided on an outer surface of the slinger bending portion 320. The sealing member 340 may include an elastically deformable rubber.

The sealing member 340 may be integrally provided with the slinger 300. In addition, the sealing member 340 may be integrally provided on the slinger bending portion 320 through insert injection molding.

The sealing member 340 may seal between the first surface 101 of the hub 100 and the slinger fixing portion 310, thereby blocking the entry of external foreign substances such as moisture between the first surface 101 of the hub 100 and the slinger fixing portion 310.

The frame 400 may be coupled to the outer ring 200. The frame 400 may include metal, be formed in a ring shape, and be press-fitted onto the outer ring 200. The frame 400 may be spaced apart from the hub 100 and the slinger 300.

The frame 400 may include a first frame fixing portion 410, a first frame bending portion 420, a first frame extension portion 430, a second frame bending portion 440, a second frame fixing portion 450, a third frame bending portion 460, and a second frame extension portion 470.

The first frame fixing portion 410 may be fixed to an end surface 202 of the outer ring 200. In addition, the first frame fixing portion 410 may be fixed to the end surface 202 of the outer ring 200, which faces the second surface 102 of the hub 100.

The first frame fixing portion 410 may be positioned in a direction parallel to the central direction C or the radial direction R of the hub 100 and be in close contact with the end surface 202 of the outer ring 200.

The first frame bending portion 420 may be provided on one side (upper side in FIG. 4) of the first frame fixing portion 410. The first frame bending portion 420 may be formed to bend from an end of the first frame fixing portion 410 on one side in a first axial direction AX1 of the hub 100.

The first frame extension portion 430 may extend from the first frame bending portion 420 toward the second surface 102 of the hub 100, which intersects with the first surface 101 of the hub 100. The first frame extension portion 430 may extend in an inclined manner (i.e., inclines from) at a set angle from an end of the first frame bending portion 420 toward the second surface 102 of the hub 100.

The first frame extension portion 430 may be spaced apart from the second surface 102 of the hub 100. The first frame extension portion 430 may form an obtuse angle with the first frame fixing portion 410.

The second frame bending portion 440 may be provided on the opposite side (lower side in FIG. 4) of the first frame fixing portion 410. The second frame bending portion 440 may be formed to bend from an end of the first frame fixing portion 410 on the opposite side in a second axial direction AX2 of the hub 100, opposite to the first axial direction AX1 of the hub 100.

The second frame fixing portion 450 may be coupled to the second frame bending portion 440 on one side (left side in FIG. 4) and fixed to the inner surface 201 of the outer ring 200. The second frame fixing portion 450 may intersect the end surface 202 of the outer ring 200 and be fixed to the inner surface 201 of the outer ring 200, which faces the first surface 101 of the hub 100.

The second frame fixing portion 450 may be positioned in a direction parallel to the axial direction AX1 and AX2 of the hub 100 and be in close contact with the inner surface 201 of the outer ring 200.

The third frame bending portion 460 may be provided on the opposite side (right side in FIG. 4) of the second frame fixing portion 450. The third frame bending portion 460 may be formed to bend from an end of the second frame fixing portion 450 on the opposite side in the central direction C of the hub 100.

The second frame extension portion 470 may extend from the third frame bending portion 460 toward the first surface 101 of the hub 100. The second frame extension portion 470 may extend in an inclined manner (i.e., inclines from) at a set angle from an end of the third frame bending portion 460 toward the first surface 101 of the hub 100.

The second frame extension portion 470 may be positioned parallel to the slinger extension portion 330. The second frame extension portion 470 may have the same inclination angle as the slinger extension portion 330.

The free end 331 of the slinger extension portion 330 may be positioned between the second frame fixing portion 450 and the second frame extension portion 470.

The sealing portion 500 may be provided on the frame 400. The sealing portion 500 may include an elastically deformable rubber. The sealing portion 500 may be integrally provided with the frame 400. In addition, the sealing portion 500 may be integrally provided on the frame 400 through insert injection molding.

The sealing portion 500 may be spaced apart from the hub 100 and make contact with the slinger 300. The sealing portion 500 may be spaced apart from the first surface 101 and second surface 102 of the hub 100 and make contact with the slinger extension portion 330. The sealing portion 500 may include a sealing body portion 510 and a sealing lip portion 520.

The sealing body portion 510 may be provided on the frame 400. The sealing body portion 510 may include a first sealing body portion 511, a second sealing body portion 512, and a third sealing body portion 513.

The first sealing body portion 511 may completely surround the first frame extension portion 430 and be spaced apart from the second surface 102 of the hub 100. In addition, an end of the first sealing body portion 511 may be spaced apart from a first portion 102a of the second surface 102. The spacing distance between the first portion 102a of the second surface 102 and the end of the first sealing body portion 511 may be 0.3 mm to 0.4 mm.

The second sealing body portion 512 may be provided on the second frame extension portion 470. The second sealing body portion 512 may have the sealing lip portion 520. The sealing lip portion 520 may be formed to protrude from an outer surface of the second sealing body portion 512, oriented toward the slinger extension portion 330.

The third sealing body portion 513 may connect between the first sealing body portion 511 and the second sealing body portion 512.

The sealing body portion 510 according to the embodiment of the present disclosure may further include a sealing extension portion 514. The sealing extension portion 514 may extend from the first sealing body portion 511 to surround the first frame bending portion 420.

The sealing extension portion 514 may seal between an outer surface 203 of the outer ring 200 and the first frame fixing portion 410, thereby blocking the entry of external foreign substances such as moisture between the outer surface 203 of the outer ring 200 and the first frame fixing portion 410.

The sealing lip portion 520 may protrude from the sealing body portion 510. The sealing lip portion 520 may be formed on the second sealing body portion 512. The sealing lip portion 520 may protrude toward the slinger extension portion 330 and make contact with the slinger extension portion 330. The sealing lip portion 520 may be elastically deformed. The sealing lip portion 520 may include a first sealing lip portion 521 and a second sealing lip portion 522.

The first sealing lip portion 521 may extend from an outer surface of the second sealing body portion 512 in the first axial direction AX1 of the hub 100 and make contact with the slinger extension portion 330. The first sealing lip portion 521 may be positioned in a direction parallel to the axial direction AX1 and AX2 of the hub 100, and an end of the first sealing lip portion 521 may make contact with an outer surface of the slinger extension portion 330.

The second sealing lip portion 522 may be spaced apart from the first sealing lip portion 521. The second sealing lip portion 522 may be spaced a set distance apart from the first sealing lip portion 521 in the radial direction R of the hub 100.

The second sealing lip portion 522 may be bent from an outer surface of the second sealing body portion 512 to extend in the radial direction R of the hub 100 and make contact with the slinger extension portion 330. In addition, an end of the second sealing lip portion 522 may make contact with an outer surface of the slinger extension portion 330.

The hub 100 according to the embodiment of the present disclosure may have a groove portion 110. The groove portion 110 may be provided in the second surface 102 of the hub 100. The groove portion 110 may be recessed in a second portion 102b of the second surface 102. The second portion 102b may be spaced a set distance apart from the first portion 102a in the radial direction R of the hub 100.

Moisture that enters through a space formed between the first portion 102a of the second surface 102 and the end of the first sealing body portion 511 may be stored inside the groove portion 110.

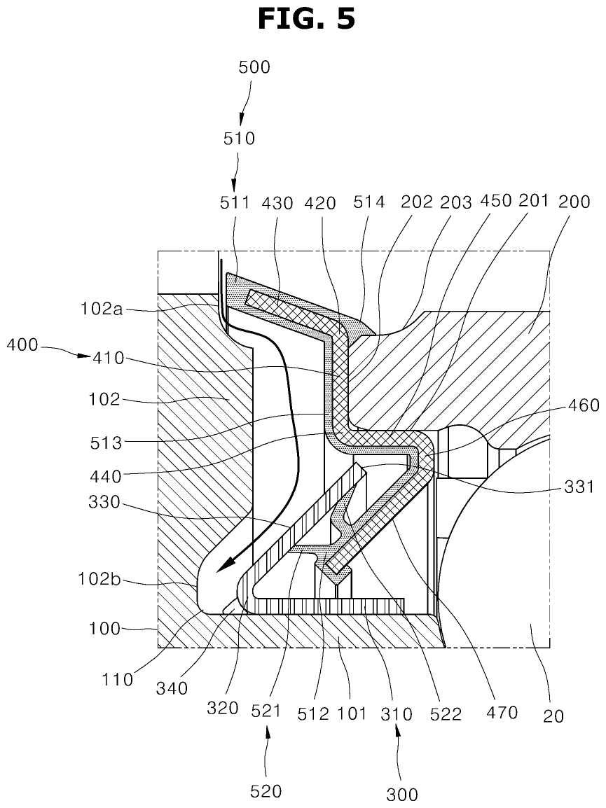

FIG. 5 is a partially enlarged cross-sectional view of FIG. 3 showing a guide path when moisture enters a wheel bearing apparatus for a vehicle according to an embodiment of the present disclosure.

Referring to FIGS. 1 to 5, the end of the first sealing body portion 511, which is spaced apart from the second surface 102 of the hub 100, may be configured to be positioned as close as possible to the first portion 102a of the second surface 102, thereby minimizing the entry of external foreign substances and improving the sealing performance.

When moisture and foreign substances enter through the space formed between the first portion 102a of the second surface 102 and the end of the first sealing body portion 511, they may be blocked by the slinger extension portion 330, which is inclined at a set angle. This prevents the moisture and foreign substances from entering the bearing portion 20, thereby improving the sealing performance.

When moisture and foreign substances enter through the space formed between the first portion 102a of the second surface 102 and the end of the first sealing body portion 511, the moisture and foreign substances may be guided to the first portion 102a of the second surface 102 by the slinger extension portion 330, which is inclined at a set angle. In other words, the moisture and foreign substances that enter may be guided toward the groove portion 110 along the inclined surface of the slinger extension portion 330. The arrows shown in FIG. 5 represent the guide path of moisture upon entry.

The moisture stored inside the groove portion 110 may be discharged to the outside through the space formed between the first portion 102a of the second surface 102 and the end of the first sealing body portion 511 by the centrifugal force of the rotating hub 100. Alternatively, this moisture may flow in the direction of gravity, that is, in the radial direction of the hub 100, and naturally be discharged to the outside through the space formed between the first portion 102a of the second surface 102 and the end of the first sealing body portion 511.

By positioning the free end 331 of the slinger extension portion 330 between the second frame fixing portion 450 and the second frame extension portion 470, and configuring this free end to be as close as possible to the second frame fixing portion 450, moisture and foreign substances entering through the space formed between the first portion 102a and the end of the first sealing body portion 511, and flowing down along the vertical surface of the first frame fixing portion 410, may be guided toward the groove portion 110 along the inclined surface of the slinger extension portion 330, which is inclined at a set angle. Accordingly, sealing performance may be improved by preventing moisture and foreign substances from entering the bearing portion 20.

The slinger extension portion 330, inclined at a set angle, and the second frame extension portion 470 may be positioned in parallel, thereby forming a narrow path between the slinger extension portion 330 and the second frame extension portion 470, which makes it difficult for moisture and foreign substances to enter.

The first sealing lip portion 521, provided between the slinger extension portion 330 and the second frame extension portion 470 and positioned parallel to the axial direction AX1 and AX2 of the hub 100, may prevent the lubricating oil filled in the bearing portion 20 from leaking to the outside through the path formed between the slinger extension portion 330 and the second frame extension portion 470. In other words, the first sealing lip portion 521 may block the leakage of lubricating oil.

The second sealing lip portion 522, positioned between the slinger extension portion 330 and the second frame extension portion 470 and configured to bend to extend in the radial direction R of the hub 100, may prevent moisture and foreign substances from entering the bearing portion 20. In other words, the second sealing lip portion 522 may block the entry of moisture and foreign substances.

In the wheel bearing apparatus 1 for a vehicle according to the embodiment of the present disclosure, a groove portion 110 may be provided in the hub 100 for storing moisture and foreign substances. Due to the slinger extension portion 330, inclined at a set angle, moisture and foreign substances that enter may be guided by the slinger extension portion 330 and stored in the groove portion 110, thereby preventing moisture and foreign substances from entering the bearing portion 20.

In the wheel bearing apparatus 1 for a vehicle according to the embodiment of the present disclosure, the slinger extension portion 330, inclined at a set angle, and the second frame extension portion 470 may be positioned in parallel, thereby forming a narrow path between the slinger extension portion 330 and the second frame extension portion 470, which may prevent moisture and foreign substances from entering the bearing portion 20.

In the wheel bearing apparatus 1 for a vehicle according to the embodiment of the present disclosure, the first sealing lip portion 521 and the second sealing lip portion 522 may be provided between the slinger extension portion 330 and the second frame extension portion 470 to block the leakage of lubricating oil filled in the bearing portion 20 and block the entry of moisture and foreign substances toward the bearing portion 20.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wheel bearing apparatus, the wheel bearing apparatus comprising:
a hub rotatably coupled to a wheel;
an outer ring spaced apart from an outer side of the hub and fixed to a vehicle body;
a slinger coupled to the hub;
a frame coupled to the outer ring and spaced apart from the slinger; and
a sealing portion provided on the frame, spaced apart from the hub, and configured to contact the slinger.

2. The wheel bearing apparatus of claim 1, wherein the slinger comprises:
a slinger fixing portion fixed on a first surface of the hub;
a slinger bending portion configured to bend from the slinger fixing portion in a radial direction of the hub; and
a slinger extension portion configured to incline from the slinger bending portion toward an inner surface of the outer ring to form an acute angle with the slinger fixing portion.

3. The wheel bearing apparatus of claim 2, wherein the slinger further comprises:
a sealing member provided on the slinger bending portion and configured to form a first seal between the first surface and the slinger fixing portion.

4. The wheel bearing apparatus of claim 2, wherein the frame comprises:
a first frame fixing portion fixed to an end surface of the outer ring;
a first frame bending portion configured to bend from one side of the first frame fixing portion in a first axial direction of the hub;
a first frame extension portion configured to incline from the first frame bending portion toward a second surface of the hub, which intersects with the first surface of the hub, to form an obtuse angle with the first frame fixing portion;
a second frame bending portion configured to bend from an opposite side of the first frame fixing portion in a second axial direction of the hub, opposite to the first axial direction;
a second frame fixing portion coupled to the second frame bending portion and fixed to the inner surface of the outer ring;
a third frame bending portion configured to bend from the second frame fixing portion in a central direction of the hub; and
a second frame extension portion configured to incline from the third frame bending portion toward the first surface and positioned parallel to the slinger extension portion.

5. The wheel bearing apparatus of claim 4, wherein a free end of the slinger extension portion is positioned between the second frame fixing portion and the second frame extension portion.

6. The wheel bearing apparatus of claim 4, wherein the sealing portion comprises:
a sealing body portion provided on the frame; and
a sealing lip portion configured to protrude from the sealing body portion and to contact the slinger extension portion.

7. The wheel bearing apparatus of claim 6, wherein the sealing body portion comprises:
a first sealing body portion configured to surround the first frame extension portion and spaced apart from a first portion of the second surface;
a second sealing body portion provided on the second frame extension portion and from which the sealing lip portion protrudes; and
a third sealing body portion configured to connect the first sealing body portion and the second sealing body portion.

8. The wheel bearing apparatus of claim 7, wherein the sealing body portion further comprises:
a sealing extension portion configured to extend from the first sealing body portion to surround the first frame bending portion and to form a second seal between an outer surface of the outer ring and the first frame fixing portion.

9. The wheel bearing apparatus of claim 7, wherein the sealing lip portion comprises:
a first sealing lip portion configured to extend from the second sealing body portion in the first axial direction; and
a second sealing lip portion spaced apart from the first sealing lip portion and configured to bend from the second sealing body portion to extend in the radial direction of the hub.

10. The wheel bearing apparatus of claim 4, wherein the hub has a groove portion defined therein, the groove portion being recessed in a second portion of the second surface.
